(19) United States
(12) Patent Application Publication
(10) Pub. No.: US 2025/0091477 A1
(43) Pub. Date: Mar. 20, 2025

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventor: Atsuyoshi KITA, Osaka (JP)

(21) Appl. No.: 18/966,708

(22) Filed: Dec. 3, 2024

Related U.S. Application Data
(63) Continuation of application No. PCT/JP2023/008781, filed on Mar. 8, 2023.

(30) Foreign Application Priority Data
Jun. 6, 2022 (JP) 2022-091693

(51) Int. Cl. B60L 58/12

(52) U.S. Cl. CPC B60L 58/12; B60L 2240/622; B60L 2250/16

(57) ABSTRACT

An information processing method includes: acquiring input data including a current location of an electric mover, a background map indicative of a region around the current location, a location list including a register of names of a plurality of locations, and a reach probability from the current location to each of the locations included in the location list; changing a display manner of a character indicative of the name of each of the locations according to the reach probabilities; and outputting a superimposed map obtained by superimposing the character indicative of the name of each of the locations in the display manner on the background map.

### FIELD OF INVENTION

The present disclosure relates to a technique of showing a driving range of an electric mover.

### BACKGROUND ART

Patent Literature 1 discloses a technique of calculating a driving distance of a vehicle by evaluating a plurality of links extending outward from a position of the vehicle, and displaying a driving range of the vehicle on a map image on the basis of a result of the calculation.

In the technique of Patent Literature 1, the driving range is represented by an outline of a polygonal graphic obtained by drawing a line on the map image. However, such a way of showing the driving range may confuse a user.

Patent Literature 1: Japanese Patent No. 6384876

### SUMMARY OF THE INVENTION

The present disclosure has been made to solve the above-mentioned problems, and an object thereof is to provide a technique of showing a driving range of an electric mover in such a manner that a user can understand the driving range intuitively.

An information processing method according to one aspect of the present disclosure by an information processing apparatus to cause a display device to display a reach probability of an electric mover includes: acquiring input data including a current location of the electric mover, a background map indicative of a region around the current location, a location list including a register of names of a plurality of locations, and a reach probability from the current location to each of the locations included in the location list; changing a display manner of a character indicative of the name of each of the locations according to the reach probabilities; and outputting a superimposed map obtained by superimposing the character indicative of the name of each of the locations in the display manner on the background map.

The present disclosure enables a user to understand a driving range intuitively.

### BRIEF DESCRIPTION OF THE DRAWINGS

FIG. 1 is a block diagram showing an exemplary structure of an information processing system according to a first embodiment of the present disclosure.

FIG. 2 is a flowchart showing an exemplary process of the information processing apparatus according to the first embodiment.

FIG. 3 is a table representing a location list according to the first embodiment.

FIG. 4 is an illustration representing a superimposed map according to the first embodiment.

FIG. 5 is a block diagram showing an exemplary structure of an information processing system according to a second embodiment.

FIG. 6 is a table representing a location list according to the second embodiment.

FIG. 7 is a flowchart showing an exemplary process of the information processing apparatus according to the second embodiment.

### DETAILED DESCRIPTION

### Underlying Findings for Present Disclosure

An electric mover such as an electric vehicle, which has a shorter running distance than a gasoline-powered vehicle, is required to display a driving range from a current position on a map.

Patent Literature 1 discloses a configuration in which a driving range is represented by an outline of a polygonal graphic obtained by drawing a line on a map. However, various lines may be drawn on the map to indicate, e.g., a road and a prefectural border. Therefore, displaying the driving range by drawing the line as in Patent Literature 1 may cause a user to confuse the line indicative of the driving range with a line indicative of a road or a prefectural border.

The present disclosure has been made to solve the above-mentioned problems.

(1) An information processing method according to one aspect of the present disclosure by an information processing apparatus to cause a display device to display a reach probability of an electric mover, includes: acquiring input data including a current location of the electric mover, a background map indicative of a region around the current location, a location list including a register of names of a plurality of locations, and a reach probability from the current location to each of the locations included in the location list; changing a display manner of a character indicative of the name of each of the locations according to the reach probabilities; and outputting a superimposed map obtained by superimposing the character indicative of the name of each of the locations in the display manner on the background map.

This configuration enables displaying on the display device a superimposed map that shows the character indicative of the name of each of the locations in the display manner according to the reach probabilities. Therefore, a user can clearly distinguish between the driving range and the line indicative of the road or the prefectural border. Consequently, the user can understand the driving range intuitively.

(2) In the information processing method described in (1), the change of the display manner may include changing a size of the character indicative of the name of each of the locations.

In this configuration, the size of the character is changed according to the reach probability. This enables the user to distinguish intuitively between a location indicative of a high reach probability and a location indicative of a low reach probability. Consequently, the user can understand the driving range more intuitively.

Further, this configuration enables a user with color vision deficiency to understand the driving range intuitively.

(3) The information processing method described in (1) or (2) may further include determining an initial position of the character indicative of the name of each of the locations for the background map, and the initial positions may be determined in order from a location indicated by a character in a larger size.

In this configuration, the initial positions are determined in order from a location indicated by a character in a larger size. Thus, the layout of the characters in the superimposed map can be adjusted more easily than in a case where the initial positions are determined in order from a location indicated by a character in a smaller size to generate a superimposed map.

(4) The information processing method described in any one of (1) to (3) may further include extracting a location indicative of a reach probability higher than a threshold from the location list, and the superimposed map may include a character indicative of a name of the extracted location.

This configuration can prevent a character indicative of a name of a location with a reach probability not higher than a threshold from being included in the superimposed map. Thus, a visually orderly superimposed map can be displayed on the display device. Consequently, the user can understand the driving range more intuitively.

(5) In the information processing method described in (4), in generation of the superimposed map, it may be determined whether the number of locations indicative of reach probabilities higher than the threshold exceeds a reference number, and in a case where the number exceeds the reference number, a priority for each of the locations may be determined in order from a higher reach probability, and the superimposed map may be generated on the basis of the priorities.

This configuration enables displaying on the display device a superimposed map that preferentially shows a character indicative of a name of a location with a high reach probability, and thus can respond to demand for preferentially recognizing a location with a high reach probability.

(6) In the information processing method described in (4), in generation of the superimposed map, it may be determined whether the number of locations indicative of reach probabilities higher than the threshold exceeds a reference number, and in a case where the number exceeds the reference number, a priority for each of the locations may be determined in order from a lower reach probability, and the superimposed map may be generated on the basis of the priorities.

This configuration enables displaying on the display device a superimposed map that preferentially shows a character indicative of a name of a location with a low reach probability, and thus can respond to demand for estimating how far the electric mover can travel by preferentially recognizing a location with a low reach probability.

(7) In the information processing method described in any one of (1) to (6), the locations in the location list may include a landmark location associated with a landmark attribute, and the input data may further include a movement history of the electric mover; the information processing method may further include determining on the basis of the movement history whether the number of visits by the electric mover to the current location exceeds a reference number of times; in generation of the superimposed map, the superimposed map may be generated so as to preferentially show a character indicative of a name of a location associated with the landmark attribute over a character indicative of a name of a location not associated with the landmark attribute, in a case where the number of visits is determined to be smaller than the reference number of times.

This configuration enables displaying on the display device a superimposed map that preferentially shows a character indicative of a name of a landmark location. Consequently, a user to move in an area including a location of which name is unfamiliar to the user, such as a travel destination, can understand the driving range intuitively.

(8) In the information processing method described in (7), in the generation of the superimposed map, the superimposed map may be generated so as to include more characters indicative of names of locations associated with the landmark attribute than a character indicative of a name of a location not associated with the landmark attribute.

This configuration enables displaying on the display device a superimposed map that includes more names indicated by characters of locations associated with the landmark attribute than a name indicated by a character of a location not associated with the landmark attribute. Consequently, a user to move in an area including a location of which name is unfamiliar to the user, such as a travel destination, can understand the driving range intuitively.

(9) In the information processing method described in (3), the initial position may be determined on the basis of a latitude and a longitude of each of the locations.

This configuration enables displaying on the display device a superimposed map with the initial positions reflecting the latitude and the longitude of each of the locations. Thus, the user can understand the driving range more intuitively.

(10) The information processing method described in any one of (1) to (9) may further include executing a positional adjustment of the character indicative the name of each of the locations for preventing the respective characters indicative of the names of the locations from being placed overlapped with each other on the background map.

This configuration prevents the display device from displaying a superimposed map in which respective characters indicative of names of locations are overlapped with each other. Thus, the user can understand the driving range more intuitively.

(11) In the information processing method described in any one of (1) to (10), the input data may further include a remaining power amount of the electric mover and a predicted power consumption amount for a movement of the electric mover from the current location to each of the locations; the information processing method may further include calculating the reach probabilities on the basis of the remaining power amount and the predicted power consumption amounts.

In this configuration, a reach probability is calculated on the basis of the remaining power amount of the electric mover and a predicted power consumption amount. Therefore, a reach probability can be calculated more accurately.

(12) An information processing apparatus according to another aspect of the present disclosure to cause a display device to display a reach probability of an electric mover includes: an acquisition part that acquires input data including a current location of the electric mover, a background map indicative of a region around the current location, a location list including a register of names of a plurality of locations, and a reach probability from the current location to each of the locations included in the location list; a change part that changes a display manner of a character indicative of the name of each of the locations according to the reach probabilities; and an output part that outputs a superimposed map obtained by superimposing the character indicative of the name of each of the locations in the display manner on the background map.

This configuration enables provision of an information processing apparatus that exerts the same advantageous effects as those described for the information processing method.

(13) An information processing program according to still another aspect of the present disclosure causes a computer to implement an information processing method for causing a display device to display a reach probability of an electric mover; the information processing program causes the computer to execute a process of: acquiring input data including a current location of the electric mover, a background map indicative of a region around the current location, a location list including a register of names of a plurality of locations, and a reach probability from the current location to each of the locations included in the location list; changing a display manner of a character indicative of the name of each of the locations according to the reach probabilities; and outputting a superimposed map obtained by superimposing the character indicative of the name of each of the locations in the display manner on the background map.

This configuration enables provision of an information processing program that exerts the same advantageous effects as those described for the information processing method.

The disclosure can be realized as a processing system operated by the information processing program. Additionally, it goes without saying that the program is distributable as a non-transitory computer readable storage medium like a CD-ROM, or distributable via a communication network like the Internet.

Each of the embodiments which will be described below represents a specific example of the disclosure. Numerical values, shapes, constituents, steps, and the order thereof described below are mere examples, and thus should not be construed to delimit the disclosure. Further, constituents which are not recited in the independent claims each showing the broadest concept among the constituents in the embodiments are described as selectable constituent. The respective contents are combinable with each other in all the embodiments.

### First Embodiment

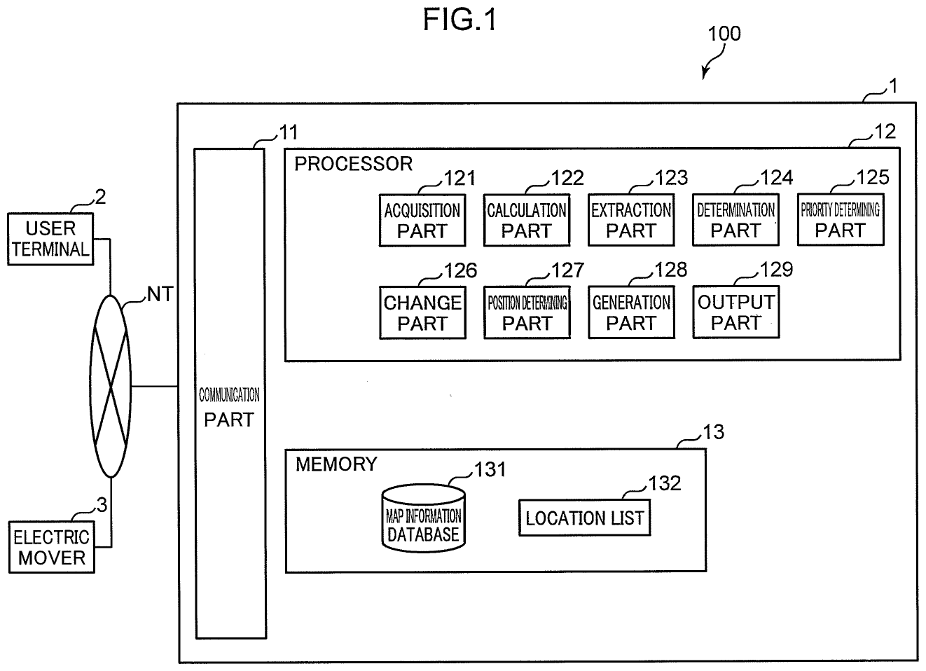

FIG. 1 is a block diagram showing an exemplary structure of an information processing system 100 including an information processing apparatus 1 according to a first embodiment of the present disclosure. The information processing system 100 includes the information processing apparatus 1, a user terminal 2, an electric mover 3, and a network NT. The information processing apparatus 1 is communicably connected with the user terminal 2 (an exemplary display device) and the electric mover 3 via the network NT. The network NT is, e.g., a wide area network including the Internet and a mobile phone communication network. The system shown in FIG. 1 includes one user terminal 2 and one electric mover 3, but may include a plurality of user terminals and electric movers. The user terminal 2 and the electric mover 3 can be uniquely determined from respective communication addresses.

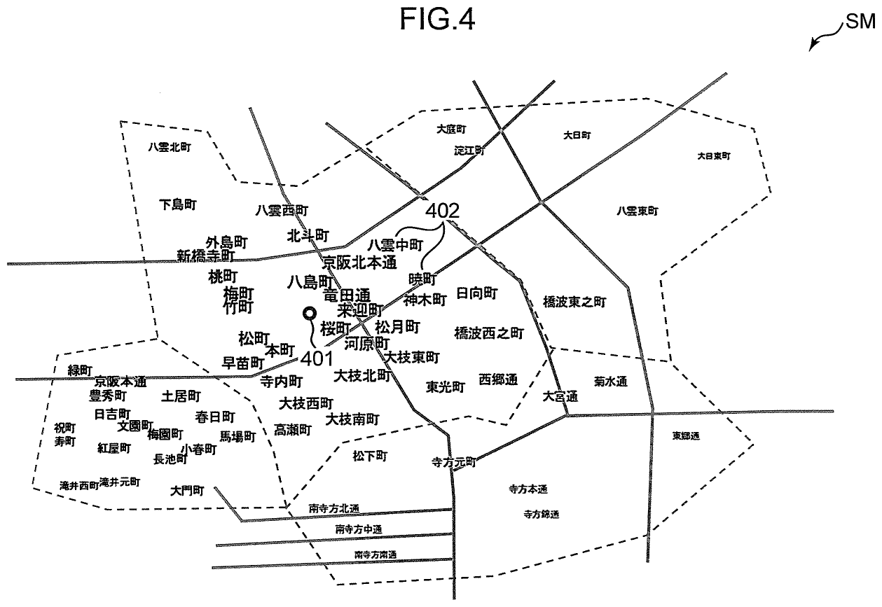

The user terminal 2 is a mobile information processing device, e.g., a tablet computer or a smartphone. The user terminal 2 is carried by a user to board the electric mover 3. The user terminal 2 displays a superimposed map SM. The superimposed map SM is a map image (see FIG. 4) obtained by superimposing a character of a name of each location on a background map to show a driving range of the electric mover 3 to the user.

The electric mover 3 travels using electricity as a power source. The electric mover 3 includes, e.g., a motor, a battery to supply electricity to the motor, an inverter to control the motor, and a display to display a map image. The electric mover 3 is, e.g., an electric vehicle, an electric motorcycle, an electric bicycle, or an electric scooter. Hereinafter, the electric mover 3 will be described as an electric vehicle. The battery is a chargeable and dischargeable secondary battery such as a lithium-ion battery and a nickel-hydrogen battery.

The user terminal 2 transmits to the information processing apparatus 1 input data for asking the information processing apparatus 1 for a driving range from a current location. The information processing apparatus 1 receives the input data, generates driving range information indicative of the driving range from the current location, and transmits it to the user terminal 2.

Next, details of the structure of the information processing apparatus 1 will be described. The information processing apparatus 1 includes a communication part 11, a processor 12, and a memory 13. The communication part 11 includes a communication circuit that connects the information processing apparatus 1 to the network NT. The communication part 11 receives the input data from the user terminal 2, and transmits the driving range information to the user terminal 2.

The processor 12 is composed of, e.g., a central processing unit, and includes an acquisition part 121, a calculation part 122, an extraction part 123, a determination part 124, a priority determining part 125, a change part 126, a position determining part 127, a generation part 128, and an output part 129, as shown in FIG. 1. The acquisition part 121 to the output part 129 do performance when the central processing unit executes a certain information processing program. However, this configuration is merely an example; the acquisition part 121 to the output part 129 may be constituted by a dedicated electric circuit, e.g., an ASIC. Each functioning part of the processor 12 shown in FIG. 1 is merely an example; a functioning part may be omitted, or a functioning part may be integrated into another functioning part. Further, a part of a process executed by the processor 12 may be executed by an unillustrated external device communicably connected to the information processing apparatus 1. For example, a process executed by the calculation part 122, which will be described later, may be executed by the external device as described above.

The acquisition part 121 acquires input data including a current location of the electric mover 3, a background map indicative of a region around the current location, a location list 132 including a register of names of a plurality of locations, and a reach probability from the current location to each of the locations included in the location list 132. Further, the acquisition part 121 according to the embodiment acquires a remaining power amount of the electric mover 3 and a predicted power consumption amount for a movement of the electric mover 3 from the current location to each of the locations as the input data.

The current location of the electric mover 3 can be acquired by communication with the user terminal 2 via the communication part 11. The current location is positional information including a latitude and a longitude. The current location may further include an altitude of the electric mover 3.

The background map indicative of the region around the current location can be acquired from a map information database 131. The background map is, e.g., a map that shows only a main road and a geographical boundary in a region within a certain range from the current location.

The map information database 131 is stored in the memory 13; in the database, map information described later and location information on a location in the world are registered. The location information includes a name of a location, and a latitude and a longitude of the location. The map information database 131 may be stored in the external device as described above.

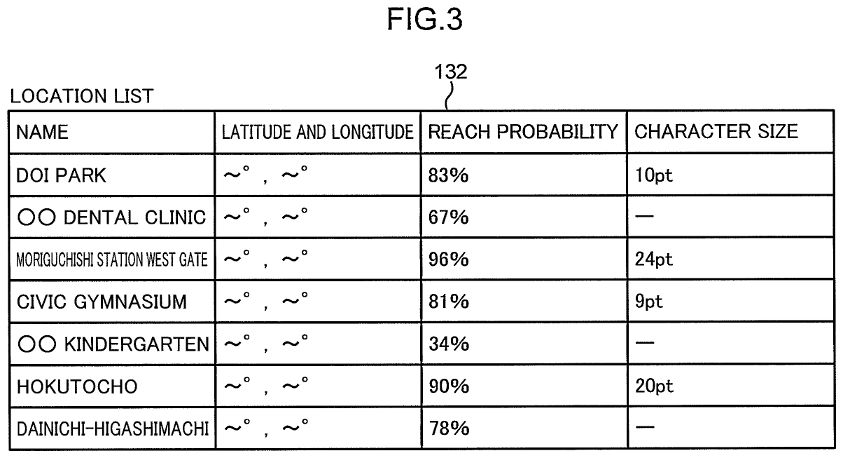

The location list 132 (see FIG. 3) including the register of the names of the locations can be acquired from the map information database 131. Here, a location list 132 including a register of names of a plurality of locations included in a region within a certain range from the current location is acquired. The location list 132 is created by, e.g., extracting from the map information database 131 location information on the locations included in the region within the certain range from the current location.

The reach probability from the current location to each of the locations included in the location list 132 can be acquired by causing the calculation part 122 to make a calculation. How the reach probability is calculated by the calculation part 122 will be described later.

The remaining power amount of the electric mover 3 indicates a current remaining power amount of the electric mover 3, and can be acquired by communication with the user terminal 2 via the communication part 11. The acquisition part 121 according to the embodiment acquires the remaining power amount of the electric mover 3 at a time of, e.g., acquisition of the current location of the electric mover 3.

The predicted power consumption amount for a movement of the electric mover 3 from the current location to each of the locations can be acquired by causing the calculation part 122 to make a calculation. How the predicted power consumption amount is calculated by the calculation part 122 will be described later.

The acquisition part 121 may acquire various kinds of additional information as the input data. For example, the acquisition part 121 may acquire user identification information, vehicle information on the electric mover 3, battery information on a battery installed in the electric mover 3, date-and-time information, and display extent information. The user identification information indicates a characteristic of the user such as an identifier for the user (user ID), a weight, a sex, an age, and a height of the user. The vehicle information indicates a characteristic of a vehicle such as a vehicle type, an identifier for the electric mover 3 (mover ID), and a weight of the electric mover 3. The battery information indicates a characteristic of a battery such as an identifier for the battery (battery ID), a type of the battery, and a capacity of the battery. The date-and-time information indicates a use date and time of the electric mover 3, i.e., a date and time when input data is acquired. The date-and-time information includes, e.g., a year, a month, a day, a day of the week, and a timeframe. The timeframe includes a transmission time of the input data, and may include information indicative of a period such as the morning and the afternoon for the transmission time of the input data. The information indicative of the period may include a period obtained by dividing 24 hours by a predetermined timespan, e.g., a period from one o'clock to two o'clock and a period from two o'clock to three o'clock. The display extent information indicates an extent of the superimposed map SM to be displayed on the user terminal 2. The display extent information includes positional information on an upper left (or upper right) vertex and positional information on a lower right (or lower left) vertex of the background map to be displayed on the user terminal 2. The positional information includes a latitude and a longitude. The display extent information is changed on the basis of an amount of a manipulation by the user such as a pinch-out manipulation or a pinch-in manipulation to the superimposed map SM displayed on the user terminal 2. When acquiring the display extent information, the acquisition part 121 may acquire a location list 132 having a register of names of a plurality of locations within a display extent.

The calculation part 122 calculates a predicted power consumption amount and a reach probability on the basis of the input data acquired by the acquisition part 121.

How the predicted power consumption amount is calculated by the calculation part 122 will be described. In the calculation of the predicted power consumption amount, the calculation part 122 calculates a geographical feature between the current location and each of the locations on the basis of map information stored in the map information database 131, and inputs the calculated feature to an unillustrated trained model. The map information indicates a map with a plurality of nodes and a link connecting nodes with each other. The node is positional information indicative of a characteristic position on a road. The characteristic position includes, e.g., a crossroads of roads and an end point of a road. The link corresponds to a road.

Each of the locations is represented by a main node among the nodes included in the map information. The geographical feature between the current location and each of the locations indicates, in a case where the locations include locations P1, P2, and P3 and the current location is represented by P0, three geographical features between P0 and P1, between P0 and P2, and between P0 and P3. In this case, the three geographical features are input to the trained model.

The calculation part 122 calculates a distance of the shortest route between the current location and each of the locations as the geographical feature by using, e.g., a known pathfinding algorithm. The known pathfinding algorithm is, e.g., a Dijkstra's algorithm. The shortest route includes, e.g., a route involving a lowest cost. However, this is merely an example; the calculation part 122 may calculate the geographical feature between the current location and each of the locations by using, e.g., an external map application programming interface (API).

The geographical feature may include at least one of an altitudinal difference and the number of crossroads. The altitudinal difference is represented by a reached elevation or may be represented by an accumulated elevation on a route connecting the current location and each of the locations. The reached elevation indicates an elevational difference between the current location and the highest point on the route. The accumulated elevation indicates a total of upward or downward elevational differences on the route.

The calculation part 122 calculates a predicted power consumption amount of the electric mover 3 from the current position to each of the locations by inputting the geographical feature to the unillustrated trained model. The trained model is obtained by machine learning for a relationship between a geographical feature between two locations and a power consumption amount required for a movement between the two locations. The two locations are, e.g., a start point and an arrival point for a past travel of the electric mover 3.

In an exemplary case where three geographical features between P0 and P1, between P0 and P2, and between P0 and P3 are input, the calculation part 122 inputs the geographical features between P0 and P1, between P0 and P2, and between P0 and P3 one after another to the trained model, and acquires the respective predicted power consumption amounts for the location P1, the location P2, and the location P3 one after another from the trained model. The predicted power consumption amounts are thus calculated.

How the reach probability is calculated by the calculation part 122 will be described. For example, the reach probability can be calculated on the basis of the remaining power amount of the electric mover 3 and the predicted power consumption amount calculated under the procedure as described above. For example, a reach probability for a predicted power consumption amount W1 and a remaining power amount W0 can be calculated as a ratio (W0/W1) between the remaining power amount W0 and the predicted power consumption amount W1. Specifically, the calculation part 122 calculates the ratio (W0/W1), normalizes the calculated ratio to be within a range from 0 as a minimum to 1 as a maximum, and determines the normalized value as the reach probability. The reach probability calculated under the procedure as described above is associated with the name of the corresponding location and registered in the location list 132. In the location list 132 shown in FIG. 3, each value that is input in a field for the reach probability is an imaginary value shown for easy understanding of the description, and thus should not be construed to delimit the present disclosure.

The calculation part 122 according to the embodiment calculates a difference between the reach probability for each of the locations registered in the location list 132 and a threshold. The threshold is relevant to the reach probability (e.g., 80%), and prestored in, e.g., the memory 13. The calculation part 122 calculates the difference between the reach probability for each of the locations and the threshold, so that a location indicating a reach probability higher than the threshold among each of the locations included in the location list 132 is determined. The value set as the threshold can be changed as necessary.

The extraction part 123 refers to a result of the calculation by the calculation part 122 and extracts the location indicative of the reach probability higher than the threshold from each of the locations included in the location list 132.

The determination part 124 determines whether the number of locations extracted by the extraction part 123 exceeds a reference number (e.g., 300). The reference number indicates an upper limit of the number of locations to be displayed on the superimposed map SM, and is prestored in, e.g., the memory 13.

The priority determining part 125 is a functioning part that functions in a case where the determination part 124 determines that the number of locations extracted by the extraction part 123 exceeds the reference number. The priority determining part 125 determines a location to be displayed preferentially on the superimposed map SM among each of the locations extracted by the extraction part 123. The priority determining part 125 determines a priority for each of the locations extracted by the extraction part 123 to determine the location to be displayed preferentially on the superimposed map SM. The priority is a parameter indicative of necessity of displaying each of the locations. The priority determining part 125 according to the embodiment determines the priority for each of the locations in order from a higher reach probability. Thus, a location indicative of a high reach probability can be quickly recognized. The priority determining part 125 may determine the priority for each of the locations in order from a lower reach probability. In this case, how far the electric mover can travel can be quickly recognized. In a case where the determination part 124 determines that the number of locations extracted by the extraction part 123 is not larger than the reference number, the process by the priority determining part 125 is omitted.

The change part 126 changes a display manner of a character indicative of a name of each of the locations according to the reach probability for each of the locations. In the embodiment, the change part 126 changes a size (point) of the character indicative of the name of each of the locations according to the reach probability. Specifically, the change part 126 executes a process of changing a setting for the size of the character of the name of each of the locations according to the reach probability for each of the locations. For example, the change part 126 changes a setting for a size of a character so that a character of a name of a location indicative of a higher reach probability is displayed in a larger size and a character of a name of a location indicative of a lower reach probability is displayed in a smaller size. In this example, the change part 126 may change settings for sizes of characters in such a manner that the character for the location indicative of the highest reach probability is in the largest size, the character for the location indicative of the lowest reach probability is in the smallest size, and a character for a location indicative of a middle reach probability is in a size determined by proportional distribution according to the reach probability. The change part 126 may change a setting such that a character of a name of a location indicative of a lower reach probability is displayed in a larger size and a character of a name of a location indicative of a higher reach probability is displayed in a smaller size. As shown in FIG. 3, the settings for the sizes of the characters changed in the manner as described above are associated with the names of the corresponding locations and registered in the location list 132. In the location list 132 shown in FIG. 3, each value that is input in a field for the size of the character is an imaginary value shown for easy understanding of the description, and thus should not be construed to delimit the present disclosure.

The position determining part 127 determines an initial position of the character indicative of each of the locations for the background map. In the embodiment, the initial position is determined on the basis of a latitude and a longitude of each of the locations. The latitude and the longitude of each of the locations can be identified by referring to the map information database 131. In a case where the initial positions are determined under the procedure as described above, a character indicative of a name of one location and a character indicative of a name of another location may be placed overlapped with each other on the background map. In this regard, the position determining part 127 according to the embodiment executes a positional adjustment of the character indicative of the name of each of the locations for preventing the respective characters indicative of the names of the locations from being placed overlapped with each other on the background map. Specifically, the position determining part 127 determines whether characters are placed overlapped with each other on the background map, after the determination of the initial position of the character indicative of each of the locations for the background map. When determining that characters are overlapped with each other, the position determining part 127 executes a positional adjustment of the characters. Whether characters are overlapped with each other can be determined by checking whether polygons forming the characters are overlapped with each other on the background map. Alternatively, whether characters are overlapped with each other may be determined by setting a circumscribed rectangle for each of the characters and checking whether the circumscribed rectangles are overlapped with each other.

The generation part 128 generates, on the basis of the display manner of the characters changed by the change part 126 and the initial positions determined by the position determining part 127, driving range information for displaying the superimposed map SM on the user terminal 2. The driving range information includes, e.g., a program for displaying the superimposed map SM on the user terminal 2. The driving range information may be image data including the superimposed map SM.

The output part 129 transmits the driving range information generated by the generation part 128 to the user terminal 2 through the communication part 11.

The memory 13 includes a storage device that is non-volatile and rewritable, e.g., a hard disk drive or a solid-state drive. The memory 13 stores various kinds of information including the map information database 131.

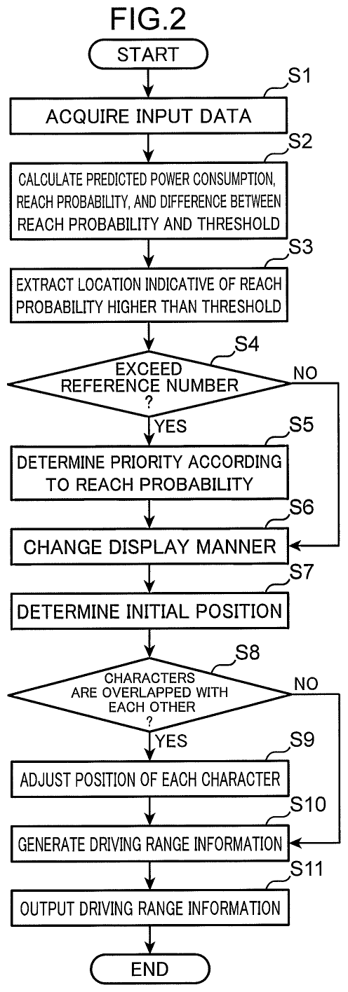

The configuration of the information processing apparatus 1 is as described above. Next, the process of the information processing apparatus 1 will be described. FIG. 2 is a flowchart showing an exemplary process of the information processing apparatus 1 according to the first embodiment. The process shown in FIG. 2 is started at a time of reception by the information processing apparatus 1 of a signal for demanding transmission of the driving range information from the user terminal 2.

In Step S1, the acquisition part 121 acquires input data. The predicted power consumption amount and the reach probability as the input data are acquired after Step S2 in the process is executed.

In Step S2, the calculation part 122 executes a process of calculating the predicted power consumption amount, a process of calculating the reach probability, and a process of calculating the difference between the reach probability and a threshold. In the embodiment, the threshold is set to, e.g., 80%.

In Step S3, the extraction part 123 refers to a result of the calculation by the calculation part 122 and extracts a location indicative of a reach probability higher than the threshold from the locations registered in the location list 132. In other words, the extraction part 123 extracts a location indicative of a reach probability higher than 80% from the locations registered in the location list 132.

In Step S4, the determination part 124 determines whether the number of locations extracted by the extraction part 123 exceeds a reference number. In the embodiment, the reference number is set to, e.g., 300. In a case where the number of locations extracted by the extraction part 123 exceeds the reference number (case of YES in Step S4), the information processing apparatus 1 shifts the process to Step S5. In a case where the number of locations extracted by the extraction part 123 is not larger than the reference number (case of NO in Step S4), the information processing apparatus 1 shifts the process to Step S6.

In Step S5, the priority determining part 125 determines a priority for each of the locations extracted by the extraction part 123. For example, in a case where there are 400 locations extracted by the extraction part 123, i.e., in a case where there are 400 locations indicative of reach probabilities higher than 80%, and the reference number is set to 300 as described above, it is necessary to determine 300 locations to be displayed preferentially on the superimposed map SM from the 400 locations. In this regard, the priority determining part 125 according to the embodiment determines the priority for each of the locations in order from a higher reach probability. Accordingly, in the embodiment, top 300 locations with the highest reach probabilities are displayed on the superimposed map SM.

In Step S6, the change part 126 changes a display manner of a character indicative of a name of each of the locations according to the reach probability for each of the locations. The change part 126 according to the embodiment changes a setting for a size of a character so that a character of a name of a location indicative of a higher reach probability is displayed in a larger size and a character of a name of a location indicative of a lower reach probability is displayed in a smaller size. For example, in the example shown in FIG. 3, the reach probability for “MORIGUCHISHI STATION WEST GATE” is higher than the reach probability for “DOI PARK”. Thus, in the embodiment, the change part 126 changes a setting for a size of a character so that the character indicative of “MORIGUCHISHI STATION WEST GATE” is displayed in a larger size than the character indicative of “DOI PARK” on the superimposed map SM.

In Step S7, the position determining part 127 determines the initial position of the character indicative of each of the locations for the background map.

In Step S8, the position determining part 127 determines whether characters are placed overlapped with each other on the background map. In a case where the characters are overlapped with each other (case of YES in Step S8), the information processing apparatus 1 shifts the process to Step S9. In a case where the characters are not overlapped with each other (case of NO in Step S8), the information processing apparatus 1 shifts the process to Step S10.

In Step S9, the position determining part 127 adjusts a position of each of the characters on the background map to eliminate the overlap of the characters.

In Step S10, the generation part 128 generates driving range information for displaying the superimposed map SM on the user terminal 2.

In Step S11, the output part 129 transmits the driving range information to the user terminal 2 through the communication part 11. FIG. 4 is an illustration representing the superimposed map SM according to the first embodiment. The superimposed map SM includes a background map of a region within a certain range from a current location 401 of the electric mover 3. The superimposed map SM includes a plurality of characters 402 superimposed on the background map. The characters 402 indicate respective names of the locations registered in the location list 132. In the example shown in FIG. 4, respective characters 402 for higher reach probabilities with respect to the current location 401 are displayed in a larger size. Thus, overall, a character 402 farther away from the current location 401 is displayed in a smaller size.

As described above, the information processing apparatus 1 according to the embodiment enables displaying on the user terminal 2 the superimposed map SM that shows the character indicative of the name of each of the locations in the display manner according to the reach probabilities. Therefore, the user can clearly distinguish between the driving range and the line indicative of the road or the prefectural border. Consequently, the user can understand the driving range intuitively.

### Second Embodiment

The information processing apparatus 1A according to the second embodiment refers to the number of visits to the current location, and preferentially displays a landmark location on the superimposed map SM when determining that the number of visits is smaller than a reference number of times. In other words, in a case where the current location is determined to be an area unfamiliar to the user, the landmark location is displayed preferentially on the superimposed map SM. In the second embodiment, the same constituents as those in the first embodiment are denoted by the same reference numerals, and the description thereof will be omitted.

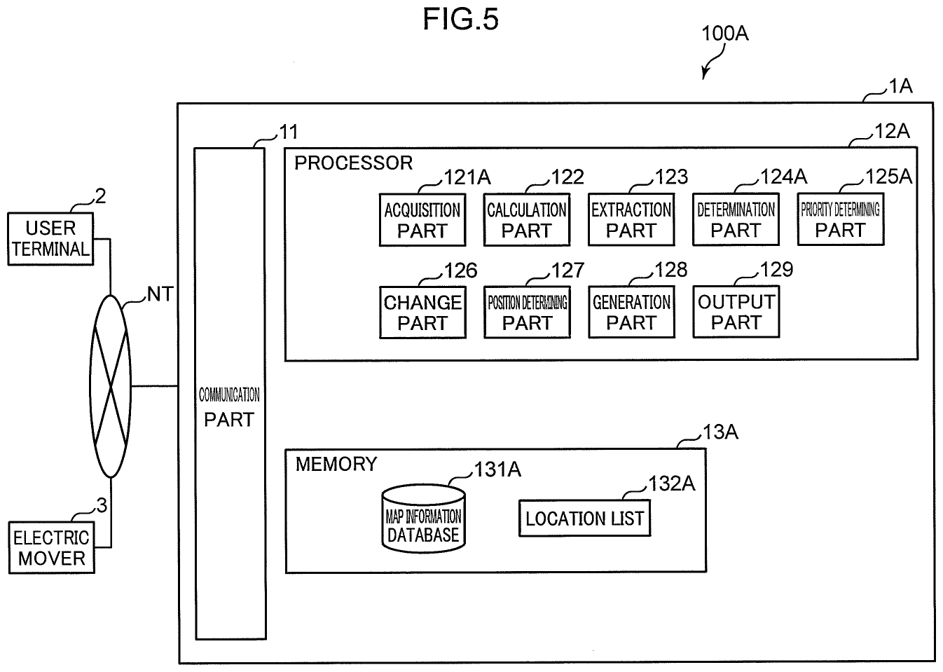

FIG. 5 is a block diagram showing an exemplary structure of an information processing system 100A including an information processing apparatus 1A according to the second embodiment of the present disclosure. The information processing apparatus 1A includes the communication part 11, a processor 12A, and a memory 13A. The processor 12A includes an acquisition part 121A, a determination part 124A, and a priority determining part 125A instead of the acquisition part 121, the determination part 124, and the priority determining part 125 described in the first embodiment. The memory 13A has a map information database 131A instead of the map information database 131 described in the first embodiment.

The acquisition part 121A further acquires a movement history of the electric mover 3 as the input data. The movement history can be acquired from the electric mover 3 via the communication part 11. The movement history is acquired at a time when, e.g., the electric mover 3 is powered off after completion of a travel of the electric mover 3. The movement history is stored in, e.g., the memory 13A. The movement history may be transmitted to the information processing apparatus 1A via the user terminal 2. In this case, the user terminal 2 and the electric mover 3 are connected with each other via a short-range wireless communication.

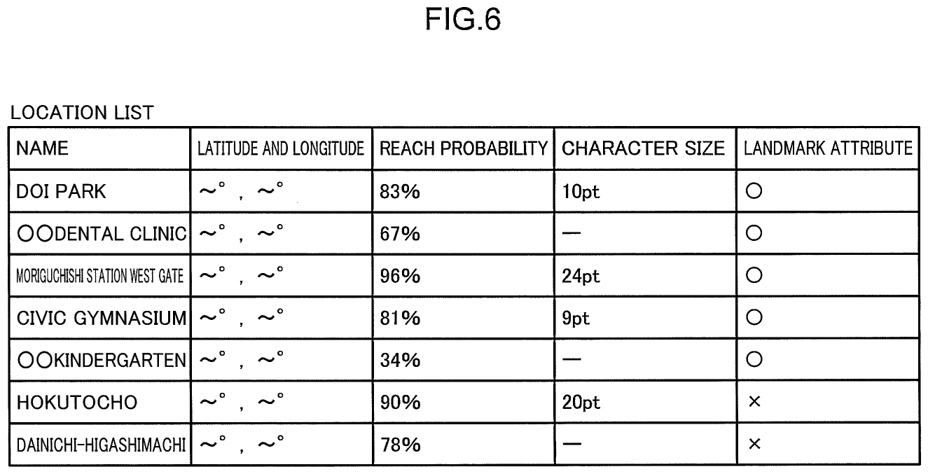

The acquisition part 121A acquires a location list 132A (see FIG. 6) having a register of names of a plurality of locations. The locations in the location list 132A include a landmark location associated with a landmark attribute. The landmark location includes a location such as a facility, a tourist attraction, a mountain, or a river. The location list 132A can be acquired from the map information database 131A that further includes information indicating whether each location is a landmark as the location information.

The determination part 124A executes a process of determining whether the number of visits by the electric mover 3 to the current location of the electric mover 3 exceeds a reference number of times (e.g., 10 times). The number of visits by the electric mover 3 to the current location can be identified by, e.g., checking the movement history of the electric mover 3 and the date-and-time information. Specifically, the number of visits can be identified by checking whether the movement history has records for a plurality of days (e.g., 10 days) of movement of the electric mover 3 around the current location. The reference number of times is prestored in, e.g., the memory 13A.

The priority determining part 125A is a functioning part that functions in a case where the determination part 124A determines that the number of visits by the electric mover 3 to the current location is not larger than the reference number of times. The priority determining part 125A refers to the location list 132A, and determines priorities such that a priority for a location associated with the landmark attribute is higher than a priority for a location not associated with the landmark attribute. Specifically, the priority determining part 125A determines priorities to display a superimposed map SM that preferentially shows a character indicative of a name of a location associated with the landmark attribute over a character indicative of a name of a location not associated with the landmark attribute. In other words, the priority determining part 125A determines the priorities so that the superimposed map SM preferentially shows a character indicative of a name of a landmark location such as a commercial facility or a tourist attraction over a character indicative of a name of a location such as a city, a ward, a town, or a village. The priority determining part 125A according to the embodiment determines the priorities to output to the user terminal 2 a superimposed map SM that includes more names indicated by characters of locations associated with the landmark attribute than a name indicated by a character of a location not associated with the landmark attribute. In a case where the determination part 124A determines that the number of visits by the electric mover 3 to the current location exceeds the reference number of times, the process by the priority determining part 125A is omitted. In this case, the information processing apparatus 1A executes the same process as the process executed by the information processing apparatus 1.

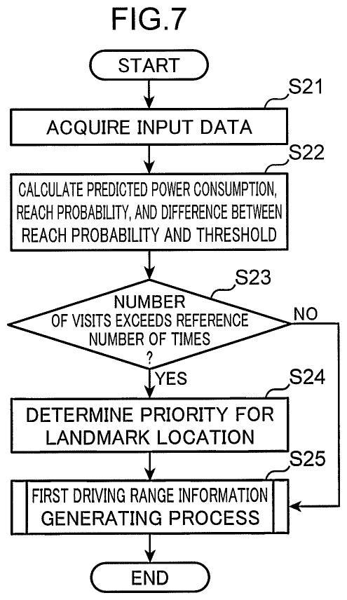

The configuration of the information processing apparatus 1A is as described above. Next, a process of the information processing apparatus 1A will be described. FIG. 7 is a flowchart showing an exemplary process of the information processing apparatus 1A according to the second embodiment. The process shown in FIG. 7 is started at a time of reception by the information processing apparatus 1A of a signal for demanding transmission of the driving range information from the user terminal 2.

In Step S21, the acquisition part 121A acquires input data including a movement history.

In Step S22, the calculation part 122 executes the process of calculating the predicted energy consumption amount, the process of calculating the reach probability, and the process of calculating the difference between the reach probability and the threshold.

In Step S23, the determination part 124A determines whether the number of visits by the electric mover 3 to the current location exceeds a reference number of times. For example, the determination part 124A determines whether the electric mover 3 has visited the current location more than 10 times. In a case where the number of visits by the electric mover 3 to the current location exceeds the reference number of times (case of YES in Step S23), the information processing apparatus 1A shifts the process to Step S25 to execute a first driving range information generating process. In Step S25 of the first driving range information generating process, the same procedure as the procedure of Step S3 to Step S11 in the first embodiment is executed. In a case where the number of visits by the electric mover 3 to the current location is not larger than the reference number of times (case of NO in Step S23), the information processing apparatus 1A shifts the process to Step S24.

In Step S24, the priority determining part 125A determines the priorities with reference to the location list 132A. Specifically, the priority determining part 125A determines the priorities to output to the user terminal 2 a superimposed map SM that includes more names indicated by characters of locations associated with the landmark attribute than a name indicated by a character of a location not associated with the landmark attribute.

The information processing apparatus 1A having ended Step S24 shifts the process to Step S6 in Step S25 of the first driving range information generating process.

Thus, the information processing apparatus 1A according to the embodiment enables displaying on the user terminal 2 the superimposed map SM that preferentially shows the character indicative of the name of the landmark location. Consequently, a user to move in an area including a location of which name is unfamiliar to the user, such as a travel destination, can understand the driving range intuitively.

### Modifications

(1) In the first embodiment, as an example of the change of the display manner of the character indicative of the name of each of the locations, a case where the size of the character is changed is described. However, the present disclosure is not limited to this; various methods may be implemented to change the display manner. For example, instead of or in addition to the change of the size of the character, a font of the character, a thickness of the character, a color of the character, a brightness of the character, or a density for the character may be changed according to the reach probability. Alternatively, instead of or in addition to the change of the size of the character, the character may be underlined, slanted, blinked, or surrounded by a graphic such as a circle or a square.

(2) In the first embodiment, an example in which the priority determining part 125 determines the priority for each of the locations in the case where the number of locations extracted by the extraction part 123 exceeds the reference number is described, but the present disclosure is not limited to this. For example, in the case where the number of locations extracted by the extraction part 123 exceeds the reference number, a location to be displayed on the superimposed map SM may be randomly selected regardless of the reach probability or the like. In this case, the process by the priority determining part 125 is omitted; thus, a load by the processing on the processor 12 can be reduced.

(3) In the second embodiment, the priority determining part 125A may further execute a process of determining a priority for each of locations not associated with the landmark attribute (hereinafter, referred to as a non-landmark location). For example, the priority determining part 125A may determine a higher priority for a non-landmark location indicative of a higher reach probability. Thus, a superimposed map SM that preferentially shows a landmark location over a non-landmark location, and preferentially shows a non-landmark location indicative of a higher reach probability among the non-landmark locations can be displayed.

(4) In the second embodiment, an example in which the movement history of the electric mover 3 is acquired to determine whether the number of visits by the electric mover 3 to the current location exceeds the reference number of times is described. In this regard, as a movement history, the acquisition part 121A may acquire a movement history of the user stored in the user terminal 2 as well as the movement history of the electric mover 3. In this case, whether the user has visited the current location by a method other than the electric mover 3 (e.g., by train) can be checked. Thus, the number of visits can be determined more exactly.

(5) In the first and second embodiments, examples in which the superimposed map SM is displayed on the user terminal 2 to enable the user to understand the driving range of the electric mover 3 is described. In this regard, information displayed on the user terminal 2 for understanding by the user of the driving range of the electric mover 3 is not limited to these examples. For example, image data obtained by superimposing a character in a size changed according to the reach probability with respect to the current location of the electric mover 3 on a background (e.g., plain background) other than a map may be displayed on the user terminal 2. In other words, a reach probability for a location with respect to the current location may be indicated in a manner similar to a word cloud on the user terminal 2. Such a configuration also can exert the same effects as those described for each of the embodiments.

The present disclosure, which enables a user to understand a driving range intuitively, is applicable to and useful for an electric mover.

1. An information processing method by an information processing apparatus to cause a display device to display a reach probability of an electric mover, comprising:
acquiring input data including a current location of the electric mover, a background map indicative of a region around the current location, a location list including a register of names of a plurality of locations, and a reach probability from the current location to each of the locations included in the location list;
changing a display manner of a character indicative of the name of each of the locations according to the reach probabilities; and
outputting a superimposed map obtained by superimposing the character indicative of the name of each of the locations in the display manner on the background map.

2. The information processing method according to claim 1, wherein the change of the display manner includes changing a size of the character indicative of the name of each of the locations.

3. The information processing method according to claim 2, further comprising:
determining an initial position of the character indicative of the name of each of the locations for the background map, wherein
the initial positions are determined in order from a location indicated by a character in a larger size.

4. The information processing method according to claim 1, further comprising:
extracting a location indicative of a reach probability higher than a threshold from the location list, wherein
the superimposed map includes a character indicative of a name of the extracted location.

5. The information processing method according to claim 4, wherein
in generation of the superimposed map,
it is determined whether the number of locations indicative of reach probabilities higher than the threshold exceeds a reference number, and
in a case where the number exceeds the reference number, a priority for each of the locations is determined in order from a higher reach probability, and the superimposed map is generated on the basis of the priorities.

6. The information processing method according to claim 4, wherein
in generation of the superimposed map,
it is determined whether the number of locations indicative of reach probabilities higher than the threshold exceeds a reference number, and
in a case where the number exceeds the reference number, a priority for each of the locations is determined in order from a lower reach probability, and the superimposed map is generated on the basis of the priorities.

7. The information processing method according to claim 1, wherein
the locations in the location list include a landmark location associated with a landmark attribute, and
the input data further includes a movement history of the electric mover, the information processing method further comprising:
determining on the basis of the movement history whether the number of visits by the electric mover to the current location exceeds a reference number of times, wherein
in generation of the superimposed map, the superimposed map is generated so as to preferentially show a character indicative of a name of a location associated with the landmark attribute over a character indicative of a name of a location not associated with the landmark attribute, in a case where the number of visits is determined to be smaller than the reference number of times.

8. The information processing method according to claim 7, wherein
in the generation of the superimposed map, the superimposed map is generated so as to include more characters indicative of names of locations associated with the landmark attribute than a character indicative of a name of a location not associated with the landmark attribute.

9. The information processing method according to claim 3, wherein the initial position is determined on the basis of a latitude and a longitude of each of the locations.

10. The information processing method according to claim 1, further comprising:
executing a positional adjustment of the character indicative of the name of each of the locations for preventing the respective characters indicative of the names of the locations from being placed overlapped with each other on the background map.

11. The information processing method according to claim 1, wherein
the input data further includes a remaining power amount of the electric mover and a predicted power consumption amount for a movement of the electric mover from the current location to each of the locations, the information processing method further comprising:
calculating the reach probabilities on the basis of the remaining power amount and the predicted power consumption amounts.

12. An information processing apparatus to cause a display device to display a reach probability of an electric mover, comprising:
an acquisition part that acquires input data including a current location of the electric mover, a background map indicative of a region around the current location, a location list including a register of names of a plurality of locations, and a reach probability from the current location to each of the locations included in the location list;
a change part that changes a display manner of a character indicative of the name of each of the locations according to the reach probabilities; and
an output part that outputs a superimposed map obtained by superimposing the character indicative of the name of each of the locations in the display manner on the background map.

13. A non-transitory computer readable recording medium storing an information processing program causing a computer to implement an information processing method for causing a display device to display a reach probability of an electric mover, the information processing program causing the computer to execute a process of:
acquiring input data including a current location of the electric mover, a background map indicative of a region around the current location, a location list including a register of names of a plurality of locations, and a reach probability from the current location to each of the locations included in the location list;
changing a display manner of a character indicative of the name of each of the locations according to the reach probabilities; and
outputting a superimposed map obtained by superimposing the character indicative of the name of each of the locations in the display manner on the background map.
